(19) United States
(12) Patent Application Publication
(10) Pub. No.: US 2004/0160329 A1
(43) Pub. Date: Aug. 19, 2004

(54) Method and apparatus for reliable carbon monoxide detection

(76) Inventor: John Flanc, Lamont, IL (US)

Correspondence Address: Christopher N. George, McAndrews, Held & Malloy, Ltd., 34th Floor, 500 West Madison Street, Chicago, IL, 60661, US

(21) Appl. No.: 10/367,051

(22) Filed: Feb. 14, 2003

(51) Int. Cl. G08B 17/10

(52) U.S. Cl. 340/632; 454/342; 454/343

(57) ABSTRACT

Certain embodiments of the present invention provide a system and method for improved, reliable carbon monoxide detection. The system includes a carbon monoxide detector for detecting carbon monoxide, an appliance powered by a fossil fuel, and a reliability module removing power supplied to the appliance when power to the carbon monoxide detector is exhausted. The reliability module may also remove power supplied to the appliance when carbon monoxide is detected above a threshold concentration. The reliability module may also remove power supplied to a control device controlling the appliance when power to the carbon monoxide detector is exhausted. The control device may include a temperature control. The system may also include a safety device that is activated when power to the carbon monoxide detector is exhausted. The safety device may include a fan. Additionally, the reliability module may include a switch for controlling power supplied to the appliance.

### BACKGROUND OF THE INVENTION

The present invention generally relates to carbon monoxide detection. More specifically, the present invention relates to improved, reliable carbon monoxide detection.

Carbon monoxide is a colorless, odorless, and tasteless gas. Carbon monoxide is produced from the burning of hydrocarbon-based fuels, such as natural gas, gasoline, oil, coal, and wood. Carbon monoxide is typically produced when hydrocarbon-based fuels are burned incompletely.

Many sources may produce carbon monoxide. For example, a stove, a furnace, a water heater, a fireplace, an engine, or other fossil fuel-powered device produces carbon monoxide when burning is incomplete. Carbon monoxide may be produced by a fuel-burning appliance due to an error or defect in the appliance or in installation of the appliance, improper maintenance, and/or incomplete burning of fuel, for example. Carbon monoxide may accumulate due to improper ventilation, for example.

Carbon monoxide may be inhaled into a person's lungs. Carbon monoxide enters the bloodstream through the lungs. Carbon monoxide displaces oxygen in the bloodstream and reduces the blood's ability to transport oxygen throughout a person's body. Carbon monoxide poisoning may disrupt function of the heart, brain, and other organs.

Carbon monoxide detectors, such as detectors made by First Alert™, Honeywell™, and Kidde™, may be used to detect the presence of carbon monoxide in an environment. A carbon monoxide detector indicates a concentration of carbon monoxide greater than a threshold amount. If an excess concentration is present for more than a defined amount of time, an alarm is triggered. Carbon monoxide detectors are typically battery-powered.

Currently, if (a battery or other source powering a carbon monoxide detector is exhausted, the carbon monoxide detector does not function. That is, a carbon monoxide detector is unable to indicate the presence of a potentially dangerous amount of carbon monoxide in an area.

Therefore, a system that helps ensure reliability of a carbon monoxide detector would be highly desirable. Additionally, a system that monitors power to a carbon monoxide detector would be highly desirable. Thus, there is a need for a system and method for improved, reliable carbon monoxide detection.

### BRIEF SUMMARY OF THE INVENTION

Certain embodiments of the present invention provide a system and method for improved, reliable carbon monoxide detection. The system includes a carbon monoxide detector for detecting carbon monoxide, an appliance powered by a fossil fuel, and a reliability module that removes power supplied to the appliance when power to the carbon monoxide detector is exhausted. The reliability module may also remove power supplied to the appliance when carbon monoxide is detected at a concentration above a threshold concentration. The reliability module may also remove power supplied to a control device controlling the appliance when power to the carbon monoxide detector is exhausted. In an embodiment, the control device includes a temperature control. The system may also include a safety device that is activated when power to the carbon monoxide detector is exhausted. In an embodiment, the safety device includes a fan. Additionally, the reliability module may include a switch for controlling power supplied to the appliance.

The method includes supplying power to an appliance and monitoring power supplied to a carbon monoxide detector. The method includes interrupting power supplied to the appliance when power supplied to the carbon monoxide detector is interrupted. Additionally, the method includes triggering an alarm when power supplied to the carbon monoxide detector is interrupted. The method may include triggering a safety device when power supplied to the carbon monoxide detector is interrupted. In an embodiment, the safety device includes a fan. Additionally, the method may include interrupting power supplied to the appliance when carbon monoxide is detected above a threshold concentration.

In an embodiment, power may be supplied to the appliance through a control device. The control device may include a temperature control, for example. The method may include disabling operation of the appliance through a control device when power supplied to the carbon monoxide detector is interrupted. In an embodiment, a switch is used to interrupt power supplied to the appliance.

Certain embodiments of an improved carbon monoxide detection system include a carbon monoxide detector for detecting carbon monoxide, a control device for controlling operation of an appliance, and a reliability module removing power from the control device when the carbon monoxide detector loses power. The reliability module may include a switch to interrupt or allow the flow of electricity to the control device. The control device may control power to the appliance. The system may also include a safety device for dispersing carbon monoxide that is activated when the carbon monoxide detector loses power. The system may further include an alarm triggered when the carbon monoxide detector loses power.

### BRIEF DESCRIPTION OF SEVERAL VIEWS OF THE DRAWINGS

FIG. 1 illustrates a carbon monoxide detection system used in accordance with an embodiment of the present invention.

FIG. 2 illustrates a carbon monoxide detection system used in accordance with an embodiment of the present invention.

FIG. 3 illustrates a carbon monoxide detection system used in accordance with an embodiment of the present invention.

FIG. 4 shows a flow diagram for a method of carbon monoxide detection used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention may be used to help ensure reliable detection of carbon monoxide. Certain embodiments monitor power to a carbon monoxide detector to determine operability of the carbon monoxide detector. Certain embodiments impair operation of an appliance if power is not detected at the carbon monoxide detector. Certain embodiments impair operation of an appliance if a threshold level of carbon monoxide is detected. Certain embodiments of the present invention may be used to monitor operation and reliability of a variety of systems. For purposes of illustration, certain embodiments will be discussed in relation to a carbon monoxide detector system.

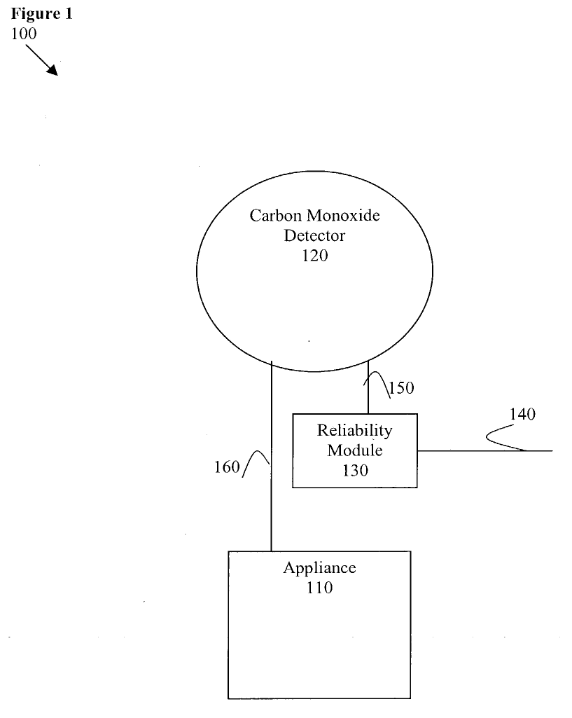

FIG. 1 illustrates a carbon monoxide detection system 100 used in accordance with an embodiment of the present invention. The system 100 includes an appliance 110, a carbon monoxide detector 120, and a reliability module 130. The appliance 110 may be a gas stove, a gas furnace, a gas water heater, a fireplace, an engine, or other fossil fuel-powered device, for example. In an embodiment, the appliance 110, the carbon monoxide detector 120, and the reliability module 130 are connected using wires. Alternatively, the components of the system 100 may also be connected via a wireless connection or infrared connection, for example.

In a prior art system, power is routed directly to the appliance 110. The carbon monoxide detector 120 is also powered by a battery or other power source, for example. The carbon monoxide detector 120 monitors levels of carbon monoxide in the surrounding air to determine if a threshold concentration has been reached. If the threshold concentration has been reached, an alarm is triggered. However, if the carbon monoxide detector 120 is not functioning properly, carbon monoxide build-up may be undetected.

In an embodiment, power is provided to the system 100 via an external power source (not pictured), such as a generator, A/C power outlet, or other power source. Power from the external power source (e.g., 24 volts, for example) is routed to the reliability module 130 via a wire 140. Power may be routed from the reliability module 130 to the carbon monoxide detector 120 via a wire 150. A wire 160 connects the carbon monoxide detector 120 with the appliance 110. Alternatively, power may be routed to the appliance 110. The wire 160 from the carbon monoxide detector 120 to the appliance 110 controls power to the appliance 110 with the reliability module 130.

In operation, power for the appliance 110 is produced from an external power source. The power is transmitted to the reliability module 130 via the wire 140. If the carbon monoxide detector 120 is activated (i.e., the detector 120 has power), then the power from the external power source is routed along the wire 150 through the carbon monoxide detector 120 to the appliance 110 using the wire 160. If the carbon monoxide detector 120 is without power or carbon monoxide is detected above the threshold concentration, then the circuit is opened and power is not routed to the appliance 110. An alarm, such as a visual flag, electronic indicator, and/or an audible alarm, is triggered to signal that the carbon monoxide detector 120 is not functioning properly or has detected carbon monoxide above a threshold level. Restoring power to the carbon monoxide detector 120 allows power to be restored to the appliance 110.

In an alternative embodiment, an additional wire may be routed from the reliability module 130 to a fan on the appliance 110. In the event of a power loss or detection of carbon monoxide above a threshold level, for example, at the carbon monoxide detector 120, power to the appliance 110 is interrupted, and power may be supplied to the fan as a safety precaution for carbon monoxide that may be in the area.

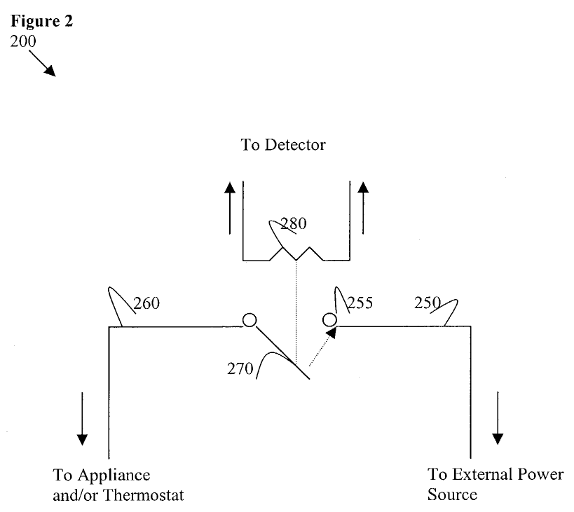

FIG. 2 illustrates a carbon monoxide detection system 200 used in accordance with an embodiment of the present invention. The system 200 includes a switch 270, a coil 280, a wire 250, and a wire 260. The components of the system 200 may be added to a carbon monoxide detector, such as the carbon monoxide detector 120 described above. The components of the system 200 may also be added to an appliance, such as the appliance 110 described above. Additionally, the components of the system 200 may be added as a separate unit or module, such as the reliability module 130, in a carbon monoxide detection system, such as the system 100 described above. The components of the system 200 may also be divided among the carbon monoxide detector 120 and the appliance 110 in the system 100.

In an embodiment, the switch 270 may be an electromagnetic switch or other type of switch or relay, for example. The switch may be a single pole double throw (SPDT) switch or a double pole double throw (DPDT) switch, for example. In an embodiment, the switch 270 includes a movable armature. In operation, a current through the coil 280 creates a magnetic field that moves the armature from a first (e.g., open) position to a second (e.g., closed) position. FIG. 2 illustrates the switch 270 with the armature positioned in the first (e.g., open) position.

In operation, power is transmitted from an external power source, such as an alternating current (AC) power supply, over the wire 250. The current reaches a terminal 255 connected to the wire 250 (similar to the wire 150). The coil 280 is connected to a power source, such as a battery, for the carbon monoxide detector 120. If the power source is charged, then current flows through the coil 280 and creates a magnetic field. The magnetic field pulls the armature of the switch 270 closed from the first position to the second position. If the switch 270 is closed, then current may flow from the wire 250 over the switch 270 to the wire 260. The wire 260 (similar to the wire 160) transmits power to an appliance 110 and/or transmits power to a thermostat, temperature control, or other control device, for example, (not pictured) controlling the appliance 110.

If the power source for the carbon monoxide detector 120 is not charged or carbon monoxide is detected by the detector 120, no current travels through the coil 280. If no current is running through the coil 280, then no magnetic field is generated around the coil 280. If no magnetic field is generated around the coil 280, then a spring in the switch 270 returns the armature to the first position. The switch 270 is open with the armature in the first position. Thus, if the carbon monoxide detector 120 is not powered and is unable to detect carbon monoxide or if carbon monoxide is detected, then power is cut-off from the thermostat and/or the appliance 110. Additionally, an alarm, such as a visual, audible, and/or electronic alarm is triggered. Replacing a battery in the carbon monoxide detector 120 and/or reducing the concentration of carbon monoxide near the detector 120, for example, resets the alarm. Operation of the thermostat and/or the appliance 110 may proceed after the alarm is reset.

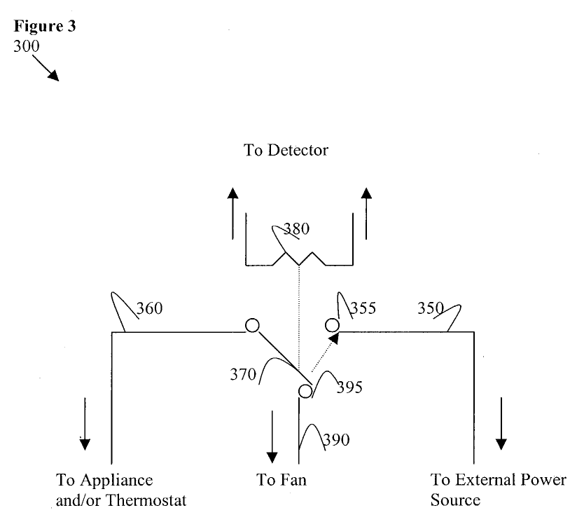

FIG. 3 illustrates a carbon monoxide detection system 300 similar to the system 200. The system 300 includes a switch 370, a coil 380, a wire 350, a terminal 255, a wire 360, a wire 390, and a terminal 395. The system 300 functions similarly to the system 200. However, the switch 370 is preferably a double pole double throw switch 370. The switch 370 moves the armature from a first terminal 355 to a second terminal 395.

If power is supplied to the carbon monoxide detector 120, the coil 380 generates a magnetic field that moves the armature of the switch 370 to the terminal 355. Current may then run to the appliance 110 and/or to a thermostat or a control for the appliance 110. If no power is supplied to the carbon monoxide detector 120 and/or carbon monoxide is detected, then a spring or other return mechanism in the switch 370 moves the armature of the switch 370 to the terminal 395. Current may then run to a fan, for example, via the wire 390. In an embodiment, the fan is located in the appliance 110. Alternatively, the fan may be located outside the appliance 110. Thus, current from the wire 390 powers a fan or other device to disperse carbon monoxide.

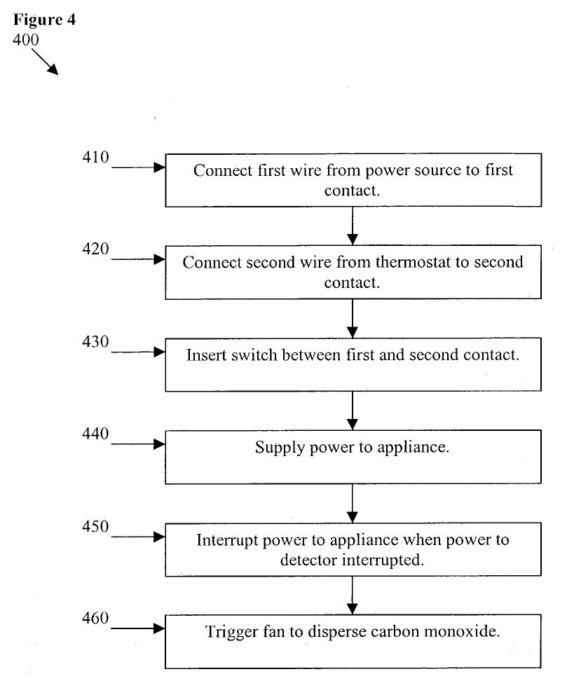

FIG. 4 shows a flow diagram 400 for a method of carbon monoxide detection used in accordance with an embodiment of the present invention. First, at step 410, a first wire (a white wire, for example) that runs between an external power source (e.g., an AC or other power source) and a thermostat or control device (a thermostat is used for purposes of illustration) for an appliance 110 is removed from a first contact on the thermostat and connected to a first contact on the carbon monoxide detector 120. The first contact may also be located in the reliability module 130. Then, at step 420, a second wire (a red wire, for example) is run between a second contact on the carbon monoxide detector 120 and a second terminal on the thermostat.

At step 430, a switch 270, 370 is inserted between the first contact and the second contact of the carbon monoxide detector 120. The switch 270, 370 may be implemented as an electromagnetic switch or other type of switch or relay, for example. The switch may be a single pole double throw (SPDT) switch or a double pole double throw (DPDT) switch, for example. At step 440, when power is supplied to the carbon monoxide detector 120 (i.e., from a battery), the switch 270, 370 is closed. That is, current from the carbon monoxide detector 120 battery flows through a coil 280, 380 and creates a magnetic field, for example. The magnetic field closes an armature of the switch 270, 370 and allows current to flow through the switch 270, 370. When the switch 270, 370 is closed, power runs to the thermostat, which may control the appliance 110.

Then, at step 450, when power is not supplied to the carbon monoxide detector 120 or the detector 120 detects carbon monoxide, the switch 270, 370 is open. The open switch 270, 370 breaks the circuit created by the first and second wires. The open switch 270, 370 prevents power generated by the external source from reaching the thermostat and/or the appliance 110. That is, the open switch 270, 370 interrupts the flow of current to the thermostat and/or the appliance 110. In an embodiment, at step 460, the open switch 370 channels power to a fan or other safety device that helps to dissipate carbon monoxide around the appliance 110, the thermostat, and/or the carbon monoxide detector 120. Additionally, in an embodiment, a gas supply may be shut off while power is not supplied to the carbon monoxide detector 120. Restoring power to the carbon monoxide detector 120 or reduction of carbon monoxide below a certain threshold closes the switch 270, 370 and re-establishes the circuit providing power to the thermostat to operate the appliance 110, for example.

Thus, certain embodiments of the present invention provide a system and method for reliable carbon monoxide detection. As long as the carbon monoxide detector 120 has power, the appliance 110 has power and may operate normally. If the carbon monoxide detector 120 loses power, then power to the appliance 110 is interrupted, and the appliance 110 is disabled to help prevent undetected carbon monoxide build-up. Additional safety features, such as a fan, may be used in the event of a battery drain at the carbon monoxide detector 120 to help dissipate carbon monoxide.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A carbon monoxide detection system, said system comprising:
a carbon monoxide detector for detecting carbon monoxide;
an appliance powered by a fossil fuel; and
a reliability module, said reliability module removing power supplied to said appliance when power to said carbon monoxide detector is exhausted.

2. The system of claim 1, wherein said reliability module further removes power supplied to said appliance when carbon monoxide is detected above a threshold concentration.

3. The system of claim 1, wherein said reliability module removes power supplied to a control device controlling said appliance when power to said carbon monoxide detector is exhausted.

4. The system of claim 3, wherein said control device comprises a temperature control.

5. The system of claim 1, further comprising a safety device activated when power to said carbon monoxide detector is exhausted.

6. The system of claim 5, wherein said safety device comprises a fan.

7. The system of claim 1, wherein said reliability module comprises a switch for controlling power supplied to said appliance.

8. A method for reliable detection of carbon monoxide, said method comprising:
supplying power to an appliance;
monitoring power supplied to a carbon monoxide detector;
interrupting power supplied to said appliance when power supplied to said carbon monoxide detector is interrupted; and
triggering an alarm when power supplied to said carbon monoxide detector is interrupted.

9. The method of claim 8, further comprising triggering a safety device when power supplied to said carbon monoxide detector is interrupted.

10. The method of claim 9, wherein said safety device comprises a fan.

11. The method of claim 8, further comprising interrupting power supplied to said appliance when carbon monoxide is detected above a threshold concentration.

12. The method of claim 8, wherein power is supplied to said appliance through a control device.

13. The method of claim 12, wherein said control device comprises a temperature control.

14. The method of claim 8, wherein operation of said appliance is disabled through a control device when power supplied to said carbon monoxide detector is interrupted.

15. The method of claim 8, wherein a switch is used to interrupt power supplied to said appliance.

16. An improved carbon monoxide detection system, said system comprising:
a carbon monoxide detector for detecting carbon monoxide;
a control device for controlling operation of an appliance; and
a reliability module removing power from said control device when said carbon monoxide detector loses power.

17. The system of claim 16, wherein said reliability module comprises a switch to interrupt or allow the flow of electricity to said control device.

18. The system of claim 16, wherein said control device controls power to said appliance.

19. The system of claim 16, further comprising a safety device for dispersing carbon monoxide, said safety device activated when said carbon monoxide detector loses power.

20. The system of claim 16, further comprising an alarm triggering when said carbon monoxide detector loses power.

21. A carbon monoxide detection system, said system comprising:
a carbon monoxide detector for detecting carbon monoxide;
an appliance powered by a fossil fuel;
a reliability module, said reliability module removing power supplied to said appliance when power to said carbon monoxide detector is exhausted; and
a safety device for dispersing carbon monoxide, said safety device activated when said carbon monoxide detector loses power.

22. The system of claim 21, wherein said safety device comprises a fan.

23. The system of claim 21, further comprising an alarm triggering when said carbon monoxide detector loses power.

24. A reliable carbon monoxide detection system, said system comprising:
a carbon monoxide detector for detecting carbon monoxide;
a control device for controlling operation of an appliance; and
a reliability module removing power from said control device when said carbon monoxide detector detects carbon monoxide above a certain threshold.

25. The system of claim 24, wherein said reliability module comprises a switch to interrupt or allow the flow of electricity to said control device.

26. The system of claim 24, wherein said control device controls power to said appliance.

27. The system of claim 24, further comprising a safety device for dispersing carbon monoxide, said safety device activated when said carbon monoxide detector loses power.

28. The system of claim 24, further comprising an alarm triggering when said carbon monoxide detector loses power.

29. A carbon monoxide detection system, said system comprising:
a carbon monoxide detector for detecting carbon monoxide;
an appliance powered by a fossil fuel;
a reliability module, said reliability module removing power supplied to said appliance when said carbon monoxide detector detects carbon monoxide above a certain threshold concentration.

30. The system of claim 29, wherein said reliability module further removes power supplied to said appliance when said carbon monoxide detector loses power.
